(19) United States
(12) Patent Application Publication
(10) Pub. No.: US 2020/0283317 A1
(43) Pub. Date: Sep. 10, 2020

(54) Filtering a Fluid

(71) Applicant: JAT Chemical LLC, Houston, TX (US)

(72) Inventor: Owen E. Boyd, Westport, MA (US)

(73) Assignee: JAT Chemical LLC, Houston, TX (US)

(21) Appl. No.: 16/473,750

(22) PCT Filed: Dec. 27, 2017
(86) PCT No.: PCT/US17/68467

§ 371 Date: Jun. 26, 2019

Related U.S. Application Data
(60) Provisional application No. 62/441,620, filed on Jan. 3, 2017.

(51) Int. Cl. C02F 5/02; C02F 1/50; C02F 1/52; C02F 1/00

(52) U.S. Cl. CPC C02F 5/02; C02F 1/50; C02F 5/086; C02F 1/001; C02F 2001/5218; C02F 1/52

(57) ABSTRACT

A housing has an inlet and an outlet. An anti-scalant layer is contained within the housing adjacent the inlet. A disinfectant layer is contained within the housing adjacent the outlet.

### CROSS-REFERENCE TO RELATED APPLICATIONS

This application claims the benefit of U.S. Provisional Patent Application No. 62/441,620, entitled “Filtering a Fluid,” filed on Jan. 3, 2017.

### BACKGROUND

A fluid, such as water, containing calcium can leave scale on a surface when the fluid evaporates from the surface. Treating fluids, such as water, to prevent scaling is a challenge.

### BRIEF DESCRIPTION OF THE DRAWINGS

FIG. 1 is a plan view of a filter housing.

FIG. 2 is a cross-sectional view of the filter housing of FIG. 1 along sight line A.

FIG. 3 illustrates an air conditioner misting controller that uses the filter shown in FIGS. 1 and 2.

FIG. 4 is a flow chart of the operation of the filter.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

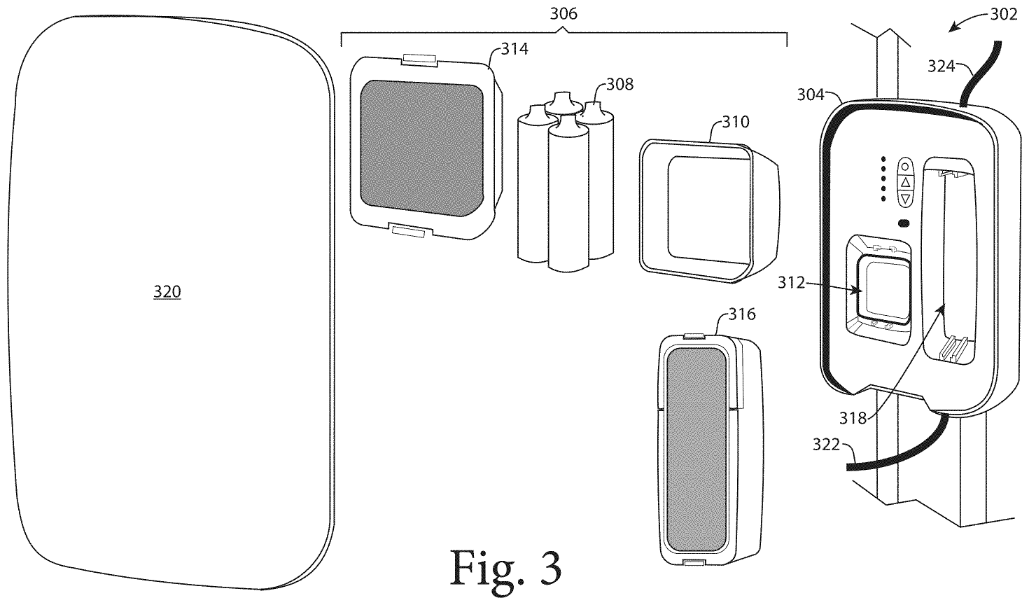

Known techniques for removing calcium from a fluid, sometimes called “softening,” have been in use for years. One technology, known as “ion exchange,” replaces calcium ions in fluid with sodium ions. Another known technique uses anti-scalant materials such template assisted crystallization (TAC) or anti-scalant chemicals such as phosphonates to remove calcium from fluid. TAC is preferred over some applications where the space available for calcium removal is limited, such as in the application described in connection with FIG. 3 below. Phosphonates require more space but may be appropriate for use in applications where space is not an issue. Another known technique uses magnetic or electromagnets to treat water.

The TAC technique uses tiny TAC beads with pitted surfaces in a fluidized bed. Calcium in a fluid flowing through the fluidized bed of TAC beads forms microcrystals in the pits of the TAC beads. The microcrystals of calcium release from the TAC beads when they reach a particular size. The released microcrystals are less likely to form scale. This approach does not, however, remove all of the calcium and the microcrystals still have some tendency to form scale.

Bacteria in the fluid increase the likelihood of scale formation because bacteria in the fluid deposited on a surface colonizes and forms a biofilm, a sticky residue on the surface. The sticky residue increases the likelihood that calcium deposits will form by allowing calcium carbonate to “stick” to the residue. While this concept is known, the knowledge is limited to those in geology (the presence of bacteria is believed to help form stalactites and stalagmites), medicine (the presence of bacterial in the blood stream helps form plaque in veins and arteries), and dentistry (the presence of bacteria in the mouth helps form plaque on teeth). The inventor is unaware of any such knowledge in the field of water treatment or in any related field.

In particular, the inventor believes that the use of anti-bacterial agents in conjunction with anti-scaling technology is new in those fields. This is illustrated by incidents in which water-softening equipment encouraged the growth of bacteria that spread disease.

The combination of anti-bacterial agents with anti-scaling technology stops biofilm from creating a sticky surface that, as learned in the unrelated fields described above, exacerbates the formation of calcium carbonate deposits. In essence, the biofilm allows calcium carbonate to stick to a surface that it may not ordinarily stick to if no biofilm were present. In addition, scientific studies have shown that calcium carbonate deposits encourage biofilms to form more easily due to their porous surface. This creates a vicious cycle of calcium carbonate deposits encouraging formation of biofilms which encourages the deposition of calcium carbonate and so on. Softening/anti-scalant technology alone will not break that cycle.

The instant technique combines anti-scalant technology with a disinfectant technology (where the word “disinfectant” has the definition adopted by the Centers for Disease Control—“usually a chemical agent (but sometimes a physical agent) that destroys disease-causing pathogens or other harmful microorganisms but might not kill bacterial spores”) to improve on the scale-reducing properties of either technique individually. The example equipment described below uses TAC as the anti-scalant and iodinated resin as the disinfectant. It will be understood, however, that different configurations may use different anti-scalants and/or different disinfectants.

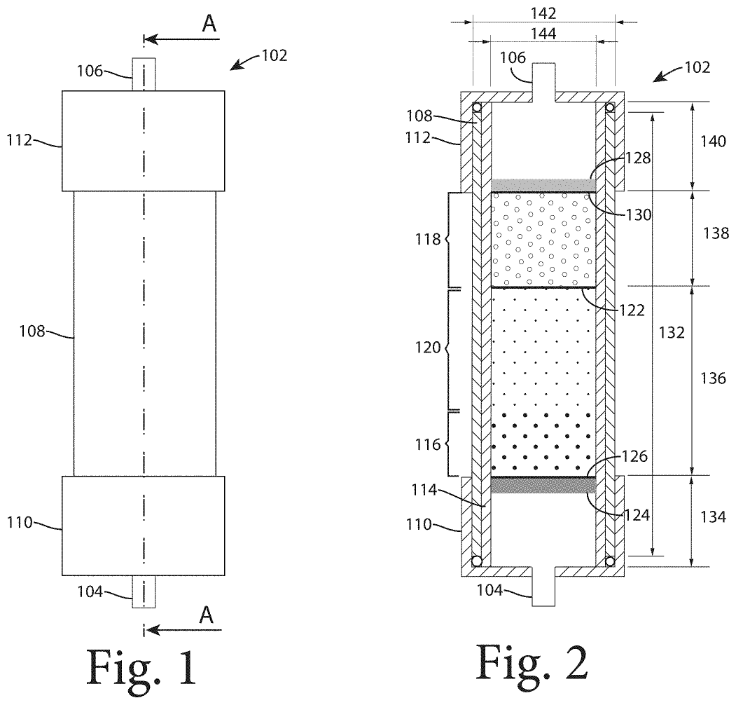

FIG. 1 is a plan view of a filter housing. FIG. 2 is a cross-sectional view of the filter housing of FIG. 1 along sight line A.

A filter housing 102 has an inlet 104 and an outlet 106. The filter housing 102 includes an outer case 108, an inlet cap 110 and an outlet cap 112. The filter housing 102 contains a replaceable filter cartridge 114. In one or more embodiments, the replaceable filter cartridge 114 is inserted into or removed from the filter housing 102 by removing the inlet cap 110 or the outlet cap 112. In one or more embodiments, the replaceable filter cartridge 114 cannot be removed from the filter housing.

The replaceable filter cartridge 114 contains a TAC layer 116 containing beads of TAC such as the next-Sand product available from Next Filtration Technologies, Inc. or a similar anti-scalant. The TAC layer 116 is adjacent the inlet 104.

The replaceable filter cartridge 114 contains an iodinated resin layer 118 containing beads of iodinated resin. The iodinated resin layer 118 is adjacent the outlet 106. The beads of iodinated resin are porous and impregnated with iodine. In one or more embodiments, the beads of iodinated resin are 350-700 microns in diameter. The beads of iodinated resin in the iodinated resin layer 118 release iodine when they are immersed in a fluid such as water. The iodine kills bacteria in the fluid. In one or more embodiments, the iodinated resin layer 118 includes, for example, Purolite's A605 product or a similar product from Thermax, or a similar anti-bacterial agent. The anti-bacterial agent may also include chlorine, bromine, ozone, or other similar anti-bacterial elements or compounds.

The replaceable filter cartridge 114 includes a TAC float area 120 between the TAC layer 116 and the iodinated resin layer 118. Fluid flowing from the inlet 104 and through the TAC layer 116 lifts TAC beads in the TAC layer 116 into a fluidized bed in the TAC float area 120. When no fluid is flowing through the replaceable filter cartridge 114, the TAC beads fall into the TAC layer 116.

The replaceable filter cartridge 114 includes a float/resin frit 122 between the TAC float area 120 and the iodinated resin layer 118. A “frit” is defined to be a porous glass disc. In one or more embodiments, the float/resin frit 122 is a 250 micron frit, which is defined to mean that the frit will block passage of particles larger than 250 microns.

The replaceable filter cartridge 114 includes an inlet filter 124 between the inlet 104 and the TAC layer 116. In one or more embodiments, the inlet filter 124 is a 25 micron polypropylene sediment/particle filter.

The replaceable filter cartridge 114 includes an inlet/TAC frit 126 between the inlet 104 and the TAC layer 116. In one or more embodiments, the inlet/TAC frit 126 is a 250 micron frit.

The replaceable filter cartridge 114 includes an outlet filter 128 between the iodinated resin layer 118 and the outlet 106. In one or more embodiments, the outlet filter 128 is a 25 micron polypropylene sediment/particle filter.

The replaceable filter cartridge 114 includes an outlet/resin frit 130 between the iodinated resin layer 118 and the outlet 106. In one or more embodiments, the outlet/resin frit 130 is a 250 micron frit.

FIG. 2 illustrates various dimensions. Dimension 132 is the height of the outer case 108. Dimension 134 is the inner height of the inlet cap 110. Dimension 136 is the distance between the inlet/TAC frit 126 and the float/resin frit 122. Dimension 138 is the distance between the float/resin frit 122 and the outlet/resin frit 130. Dimension 140 is the inner height of the outlet cap 112. Dimension 142 is the outer diameter of the outer case 108. Dimension 144 is the inner diameter of the replaceable filter cartridge 114.

The filter illustrated in FIGS. 1 and 2 can have various configurations, some of which are described in Table 1 below.

TABLE 1

| Config #3 | Config #2 | Config #1 | Dimension |
|---|---|---|---|
| 1.5″ | 1.5″ | 1.5″ | 140 |
| NA | 15/16″ | 1.5″ | 138 |
| 4 ¾″ | 3 13/16″ | 3 3/16″ | 136 |
| 1.5″ | 1.5″ | 1.5″ | 134 |
| 8 1/16″ | 8 1/16″ | 7 13/32″ | 132 |
| 2 ⅜″ | 2 ⅜″ | 2 ⅜″ | 142 |
| 1 ¾″ | 1 ¾″ | 1 ¾″ | 144 |

It will be understood that other configurations are possible. For example, these dimensions could be different if phosphonate is used as the anti-scalant.

FIG. 3 illustrates an air conditioner misting controller that uses the filter shown in FIGS. 1 and 2. An air conditioner misting controller 302 includes a control box 304 that provides the intelligence to determine when to turn the misters on and off to improve the efficiency of air conditioner compressors, as described in, for example, U.S. Pat. No. 9,198,980. The air conditioner misting controller 302 includes a battery pack 306 that includes batteries 308 that fit into a case 310. The case 310 snaps into a socket 312 to supply power to the air conditioner misting controller 302. A cover 314 secures the battery pack 306 in place.

The air conditioner misting controller 302 includes a filter pack 316 that includes a filter such as that illustrated in FIGS. 1 and 2. The filter pack 316 snaps into a receptacle 318. A cover 320 protects the components of the air conditioner misting controller 302.

An inlet hose 322 provides water from, for example, a faucet. The water is filtered by the filter pack 316 and the filtered water is routed through an outlet hose 324 to misters (not shown) as allowed by the intelligence of the control box 304. Since the water has been treated by the filter pack 316, it is less likely to cause scale on the air conditioner compressor.

In addition to use in air conditioner misting systems such as is illustrated in FIG. 3, the filter shown in FIGS. 1 and 2 can be used in any system in which scaling is possible including dish washers, laundry systems, refrigerators, water distribution systems, irrigation systems, etc.

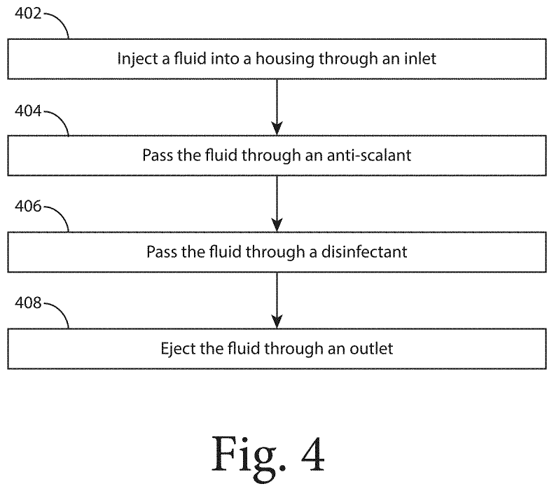

FIG. 4 illustrates a flow chart. A method for using the filter illustrated in FIGS. 1 and 2 includes injecting a fluid into a housing, such as filter housing 102, through an inlet, such as inlet 104 (block 402), passing the fluid through an anti-scalant, such as TAC layer 116 (block 404), passing the fluid through a disinfectant, such as iodinated resin layer 118 (block 406), and ejecting the fluid through an outlet, such as outlet 106 (block 408).

In one aspect, an apparatus includes a housing having an inlet and an outlet. The apparatus includes an anti-scalant layer contained within the housing adjacent the inlet. The apparatus includes a disinfectant layer contained within the housing adjacent the outlet.

Implementations may include one or more of the following. The anti-scalant layer may contain beads of TAC. The disinfectant layer may contain beads of iodinated resin.

In one aspect, a method includes injecting a fluid into a housing through an inlet. The method includes passing the fluid through an anti-scalant. The method includes passing the fluid through a disinfectant. The method includes ejecting the fluid from the housing through an outlet.

Implementations may include one or more of the following. The fluid may pass through the anti-scalant before passing through the disinfectant.

In one aspect, an apparatus includes a housing having an inlet and an outlet. The apparatus includes a template assisted crystallization (TAC) layer containing beads of TAC. The TAC layer is contained within the housing adjacent the inlet. The apparatus includes an iodinated resin layer containing beads of iodinated resin. The iodinated resin layer is contained within the housing adjacent the outlet.

Implementations may include one or more of the following. The apparatus may include a TAC float area in the housing between the TAC layer and the iodinated resin layer. The apparatus may include a float/resin frit between the TAC float area and the iodinated resin layer. The apparatus may include an inlet filter between the inlet and the TAC layer. The apparatus may include an inlet/TAC frit between the inlet and the TAC layer. The apparatus may include an outlet filter between the iodinated resin layer and the outlet. The apparatus may include an outlet/resin frit between the iodinated resin layer and the outlet. The apparatus may include a replaceable sub-housing within the housing. The replaceable sub-housing may contain the TAC layer and the iodinated resin layer. The apparatus may include a flow meter to measure the flow of fluid between the inlet and the outlet. The apparatus may include a controller housing having a snap fitting to receive the housing and a mist tube coupled to the controller housing to convert the fluid that has passed through the housing into a mist.

In one aspect, a method includes injecting a fluid into a housing through an inlet. The method includes passing the fluid through a template assisted crystallization (TAC) layer. The method includes passing the fluid through an iodinated resin layer. The method includes ejecting the fluid through an outlet.

Implementations may include one or more of the following. The method may include passing the fluid through a TAC float area between the TAC layer and the iodinated resin layer. The method may include passing the fluid through a float/resin frit between the TAC float area and the iodinated resin layer. The method may include passing the fluid through an inlet filter between the inlet and the TAC layer. The method may include passing the fluid through an inlet/TAC frit between the inlet and the TAC layer. The method may include passing the fluid through an outlet filter between the iodinated resin layer and the outlet. The method may include passing the fluid through an outlet/resin frit between the iodinated resin layer and the outlet. The method may include replacing a replaceable sub-housing within the housing. The replaceable sub-housing may contain the TAC layer and the iodinated resin layer.

In one aspect, an apparatus includes a replaceable sub-housing that fits within a housing. The sub-housing has an inlet and an outlet. The apparatus includes a template assisted crystallization (TAC) layer containing beads of TAC. The TAC layer is contained within the sub-housing adjacent the inlet. The apparatus includes an iodinated resin layer containing beads of iodinated resin. The iodinated resin layer is contained within the sub-housing adjacent the outlet.

Implementations may include one or more of the following. The apparatus may include a TAC float area in the sub-housing between the TAC layer and the iodinated resin layer. The apparatus may include a float/resin frit between the TAC float area and the iodinated resin layer. The apparatus may include an inlet filter between the inlet and the TAC layer. The apparatus may include an inlet/TAC frit between the inlet and the TAC layer. The apparatus may include an outlet filter between the iodinated resin layer and the outlet. The apparatus may include an outlet/resin frit between the iodinated resin layer and the outlet.

The operations of the flow diagrams are described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1-5. (canceled)

6. An apparatus comprising:
a housing having an inlet and an outlet;
a template assisted crystallization (TAC) layer containing beads of TAC, wherein the TAC layer is contained within the housing adjacent the inlet;
an iodinated resin layer containing beads of iodinated resin, wherein the iodinated resin layer is contained within the housing adjacent the outlet; and
a TAC float area in the housing between the TAC layer and the iodinated resin layer.

7. (canceled)

8. The apparatus of claim 6, further comprising:
a float/resin frit between the TAC float area and the iodinated resin layer.

9. The apparatus of claim 6, further comprising:
an inlet filter between the inlet and the TAC layer.

10. The apparatus of claim 6, further comprising:
an inlet/TAC frit between the inlet and the TAC layer.

11. The apparatus of claim 6, further comprising:
an outlet filter between the iodinated resin layer and the outlet.

12. The apparatus of claim 6, further comprising:
an outlet/resin frit between the iodinated resin layer and the outlet.

13. The apparatus of claim 6, further comprising:
a replaceable sub-housing within the housing, the replaceable sub-housing containing the TAC layer and the iodinated resin layer.

14. The apparatus of claim 6, further comprising:
a flow meter to measure the flow of fluid between the inlet and the outlet.

15. The apparatus of claim 6, further comprising:
a controller housing having a snap fitting to receive the housing;
a mist tube coupled to the controller housing to convert the fluid that has passed through the housing into a mist.

16. A method comprising:
injecting a fluid into a housing through an inlet;
passing the fluid through a template assisted crystallization (TAC) layer;
passing the fluid through an iodinated resin layer;
passing the fluid through a TAC float area between the TAC layer and the iodinated resin layer; and
ejecting the fluid through an outlet.

17. (canceled)

18. The method of claim 16, further comprising:
passing the fluid through a float/resin fit between the TAC float area and the iodinated resin layer.

19. The method of claim 16, further comprising:
passing the fluid through an inlet filter between the inlet and the TAC layer.

20. The method of claim 16, further comprising:
passing the fluid through an inlet/TAC fit between the inlet and the TAC layer.

21. The method of claim 16, further comprising:
passing the fluid through an outlet filter between the iodinated resin layer and the outlet.

22. The method of claim 16, further comprising:
passing the fluid through an outlet/resin frit between the iodinated resin layer and the outlet.

23. The method of claim 16, further comprising:
replacing a replaceable sub-housing within the housing, the replaceable sub-housing containing the TAC layer and the iodinated resin layer.

24. An apparatus comprising:
a replaceable sub-housing that fits within a housing, the sub-housing having an inlet and an outlet;
a template assisted crystallization (TAC) layer containing beads of TAC, wherein the TAC layer is contained within the sub-housing adjacent the inlet;
an iodinated resin layer containing beads of iodinated resin, wherein the iodinated resin layer is contained within the sub-housing adjacent the outlet;
a TAC float area in the sub-housing between the TAC layer and the iodinated resin layer.

25. (canceled)

26. The apparatus of claim 24, further comprising:
a float/resin frit between the TAC float area and the iodinated resin layer.

27. The apparatus of claim 24, further comprising:
an inlet filter between the inlet and the TAC layer.

28. The apparatus of claim 24, further comprising:
an inlet/TAC frit between the inlet and the TAC layer.

29. The apparatus of claim 24, further comprising:
an outlet filter between the iodinated resin layer and the outlet.

30. The apparatus of claim 24, further comprising:
an outlet/resin frit between the iodinated resin layer and the outlet.
